(19) United States
(12) Patent Application Publication
(10) Pub. No.: US 2002/0109325 A1
(43) Pub. Date: Aug. 15, 2002

(54) Tri-link suspension system

(76) Inventor: Jeremy Purick, East Greenbush, NY (US)

Correspondence Address: CHARLES A. TAYLOR, ATTORNEY AT LAW, 9 VALENCIA LANE, CLIFTON PARK, NY, 12065, US

(21) Appl. No.: 09/782,136

(22) Filed: Feb. 12, 2001

(51) Int. Cl. B60G 3/12

(52) U.S. Cl. 280/124.128; 280/124.1

(57) ABSTRACT

A tri-link suspension system for a motor vehicle wherein an upper control arm is pivotably coupled to a vehicle axle and further pivotably coupled to the vehicle frame. Further a right and left side lower control arm are connected to the axle and pivotably coupled to the vehicle frame. The tri-link suspension system of the present invention allows the vehicle's axle to maintain a centered position in the vehicle as the axle moves up or down or articulates. Further with the high-misalignment ball joint rod ends minimize binding and the axle is free to move. The tri-link suspension system is designed to be bolted into a vehicle to replace a standard four or five link suspension systems. The tri link suspension system is applicable to both front and rear axles.

### BACKGROUND OF THE INVENTION

1. Technical Field

The present invention generally relates to suspension systems for motor vehicles and more particularly, to a tri-link suspension mounting arrangement for supporting the front or rear axle of a motor vehicle wherein the two upper control arms and trac bar are replaced with a single U-shaped control arm assembly pivotably connected to the axle with a single ball joint assembly and pivotably connected to the frame such that in operation, the axle is able to maintain its centered position in the vehicle as the axle moves up or down or articulates

2. Discussion

Conventional motor vehicles are provided with solid axle suspension systems for absorbing impulsive forces generated by the contact of the wheels with irregular road surfaces and other vibrations while providing a smooth and comfortable ride for the vehicle occupants. In suspension systems of this type, it is common to support an axle with a set of control arms, wherein the control arms operably connect the axle to the vehicle frame. The conventional suspension system is a five (5) link system comprised of upper control arms, two lower control arms, a trac bar and a sway or stabilizing bar. The control arms control the axle's rotation due to torque and locate the axle radially in the vehicle. The trac bar locates the axle laterally in the vehicle. The sway or stabilizing bar does not locate the axle, but controls body roll. The mounting hardware for the upper and lower control arms are standard fasteners with rubber or other elastomeric bushings to reduce vibration and noise transmitted to the vehicle occupants. The joints are generally not flexible and limit axle movement.

Prior art discloses devices for supporting and positioning a vehicle stabilizing bar and a related system incorporating an antifriction sleeve made of low-friction material and integral with the straight portion of the stabilizing bar. Other art discloses a vehicle suspension system comprising upper and lower suspension arms which are pivotally connected at one end to the vehicle chassis or sub-frame and at the other end to the vehicle hub carrier. The hub carrier incorporates an arm extending from the point of connection of the hub carrier to the upper suspension arm to an upper end which is aligned vertically above the load application point between the wheel and the ground.

Other art discloses a pocketed four-link front suspension for a vehicle wherein an upper control arm on each side of the vehicle is located in an aperture within the vehicle frame and is connected to the front axle. Each upper control arm is pivotably connected to the frame and is capable of rotating into the aperture in response to a force generated by contact of its respective wheel with an irregularity in the road surface. Also disclosed is a wheel suspension for vehicles comprising a transverse wheel control link coupled to a spring element and an intermediate link and jointly supported to the vehicle body via an upright strut.

Still further prior art discloses a stabilizer support structure comprising a suspension member located at a side of the vehicle body and extending in the longitudinal direction of the vehicle body. The structure incorporates a bracket separated from the suspension member and a second bracket integral with the suspension arm and supporting one end of the suspension arm. Other art includes a suspension system comprising a wheel carrier, an upper control link having a horizontal arm, a vertical arm and a hinge portion. The hinge portion of the upper control link is connected to the vehicle subframe and front and rear lower control links connect the wheel carrier to the subframe. A trailing arm extends in a longitudinal direction of the vehicle and mounted between the vehicle body and the wheel carrier. A shock absorber assembly is mounted between the wheel carrier and the vertical arm of the upper control link so that the suspension system improves riding comfort. Other suspension systems incorporate an elastic tiebar member connected to a torsion bar and a strut bar. The elastic tiebar has an elastic material tube for absorbing any impact delivered from the strut bar and an outer or inner tube connected to the frame through a link for preventing the impact from being transmitted to the frame.

Further art discloses a quadrilateral link strut comprising a carrier for supporting the vehicle wheel and an upper arm pivotably connected to the carrier at one end and connected with the body of the vehicle at the other end. Another suspension system includes a torsion bar—strut suspension system comprising a frame member having side rails, a cross member between said side rails, upper and lower control arms, and wheel support structure connected to the control arms. Torsion bar and strut members connect the lower control arms to the cross member.

Finally prior art includes a vehicle suspension system comprising control arms pivotally connected to the side rails of a chassis frame and to the axle housing by spring supports and connectors. The reaction of the spring is exerted through a connection to the free end of an internal section, and also through the free end of an external section.

While these prior art suspension systems have proven to be commercially acceptable, they do possess several significant drawbacks. One such drawback relates to the ability of the axle to move up or down or to articulate when traversing rough roads or off the road. As a result the vehicle body will closely follow the movement of the axle.

Consequently, there remains a need in the art for a suspension system that allows the axle to move up or down or to articulate with resulting in a similar movement of the vehicle body and its occupants.

### SUMMARY OF THE INVENTION

It is therefore an object of the present invention to provide a tri-link suspension mounting system for supporting the front or rear axle of a motor vehicle wherein the two upper control arms and trac bar are replaced with a single U-shaped control arm assembly pivotably connected to the axle with a single ball joint assembly and pivotably connected to the frame such that in operation, in cooperation with the two lower control arms, the axle is able to maintain its centered position in the vehicle as the axle moves up or down or articulates

It is yet another object of the present invention to provide a suspension system that in easily bolted into the vehicle to replace existing four or five link suspension systems.

Briefly, the present invention comprises a suspension system for a motor vehicle having a tri-link suspension comprising an upper control arm pivotably coupled to a vehicle axle and further pivotably coupled to the vehicle frame. In addition right and left side lower control arms are connected to the axle and pivotably coupled to the vehicle frame. The tri-link suspension system allows the vehicle's axle to maintain a centered position in the vehicle as the axle moves up or down or articulates. Further the use of high-misalignment ball joint rod ends minimize binding and allows the axle to move freely. The tri-link suspension system is designed to be bolted into a vehicle to replace a standard five link suspension systems. The tri link suspension system of the present invention is applicable to both front and rear axles.

Other advantages and features of the present invention will become apparent from the subsequent description and the appended claims, taken in conjunction with the accompanying drawings.

### BRIEF DESCRIPTION OF THE DRAWINGS

FIG. 1 is a perspective view of the front end of a vehicle from the rear having the vehicle front axle and the front suspension system of the present invention.

FIG. 2 is a perspective view of the front upper control arm.

FIG. 3 is a perspective view of the front lower control arm.

FIG. 4 is a perspective view from the topside of the vehicle showing the connection of the upper control arm assembly and a partial view of the connection of the lower control arm assemblies to the front axle.

FIG. 5 is a partial perspective view showing the connection of the left lower control arm assembly to the left side rail of the vehicle front axle.

FIG. 6 is a perspective view of the front end of a vehicle from the front having the vehicle front axle and front suspension system of the present invention.

FIG. 7 is a perspective view of the rear end of a vehicle from the rear having the vehicle rear axle and the rear suspension system of the present invention.

FIG. 8 is a perspective view of the rear upper control arm.

FIG. 9 is a perspective view of the rear lower control arm.

FIG. 10 is a perspective view from the topside of the vehicle showing the connection of the upper control arm assembly and a partial view of the connection of the lower control arm assemblies to the rear axle.

FIG. 11 is a partial perspective view showing the connection of the left lower control arm assembly to the left side rail of the vehicle rear axle.

FIG. 12 is a perspective view of the front bracket for connecting the front upper control arm assemble to the front axle.

FIG. 13 is a perspective view of the rear bracket for connecting the rear upper control arm assemble to the rear axle.

FIG. 14 is a perspective view of the ball joint bracket for the front upper control arm and the rear upper control arm.

### DETAILED DESCRIPTION OF THE PREFERRED EMBODIMENT

Certain terminology is used in the following detailed description for convenience only and is not intended to be limiting. For example, the words “left”, “right”, “upper”, “lower”, “front” and “rear” are intended to designate direction or orientation shown in the drawings to which reference is being made. Additionally, as both the vehicle frame and the suspension system on the left and right sides of the vehicle are mirror images of each other, only one side of the frame and suspension system will be described in detail. Similar or corresponding elements of the right hand side of the vehicle are identified by the same reference numerals as used to describe those on the left-hand side of the vehicle.

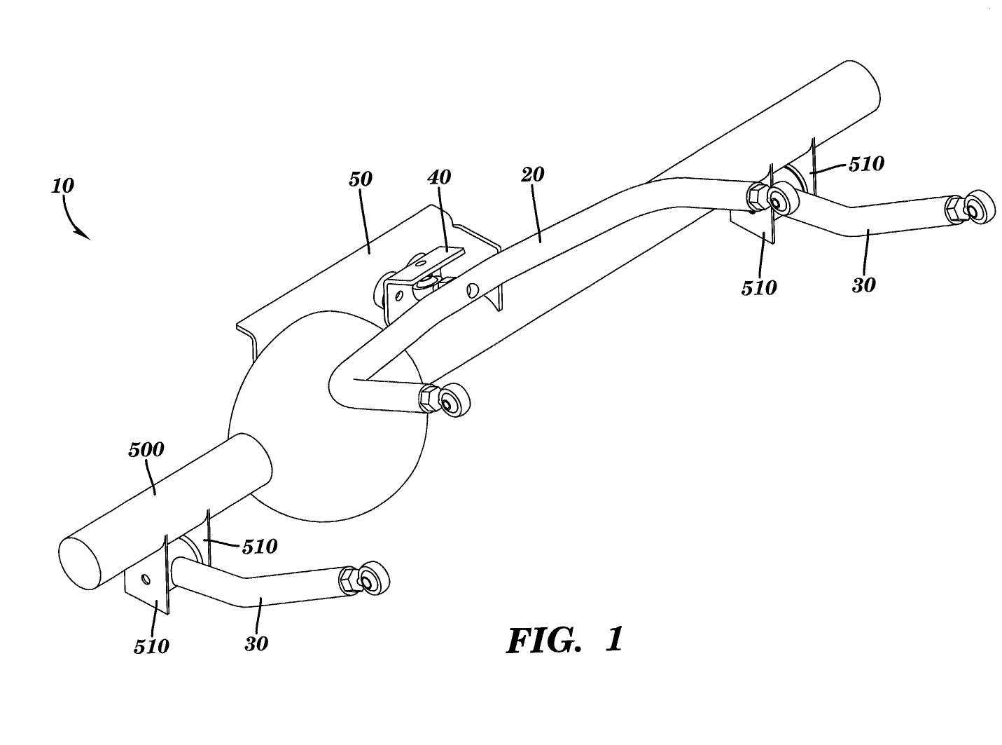

With initial reference to FIG. 1 of the drawings, the front axle of a motor vehicle is partially shown and includes a suspension system 10 having an upper front control arm 20 and right and left front lower control arms 30, an upper control arm ball joint bracket 40, a front axle bracket 50, and a front axle 500 having right and left lower control arm connector brackets 510.

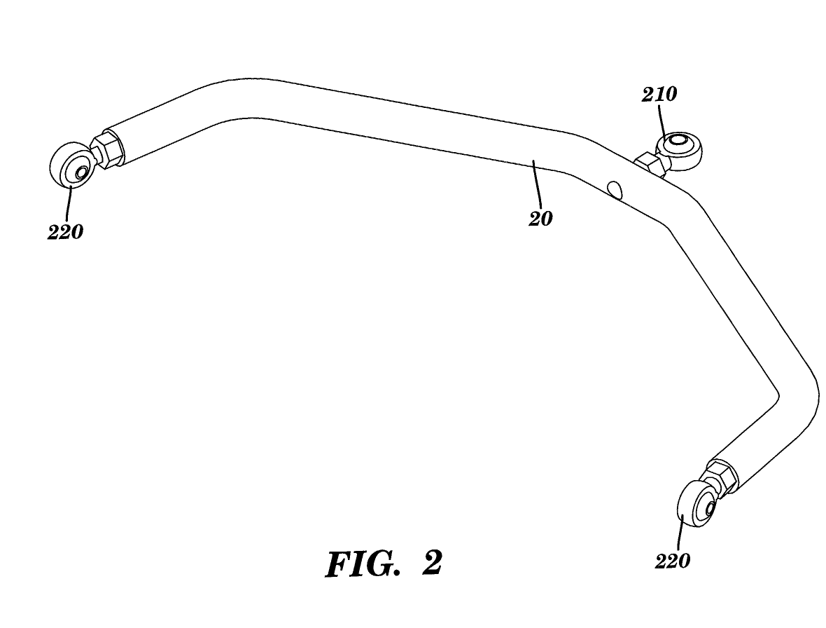

Referring now to FIG. 2, the upper control arm 20 is shown. The upper control arm 20 being U-shaped and having a ball joint assembly 210 located at the midpoint of the upper control arm 20. And further having a ball joint assembly 220 at each end of the upper control arm. The midpoint ball joint assembly 210 being connected by appropriate fastening means to the upper control arm ball joint bracket 40, shown in FIG. 1. The ball joint assembly 220 at each end of the upper control arm being connected by appropriate means to the appropriate upper control arm brackets (not shown) on the vehicle frame (not shown).

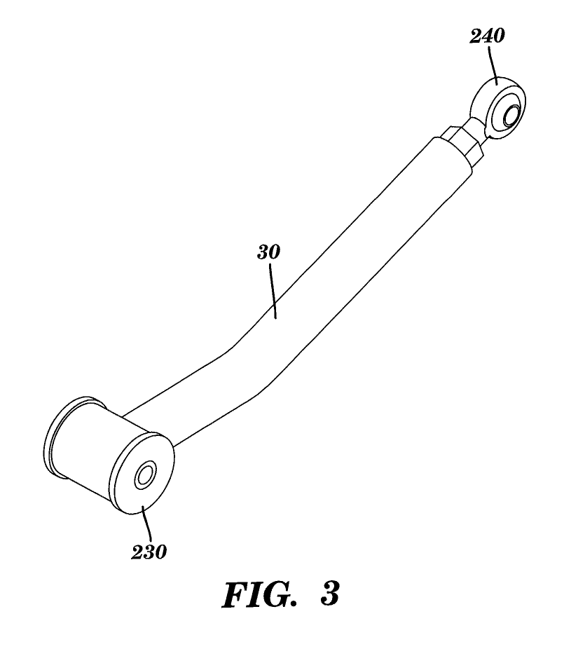

FIG. 3 demonstrates a front lower control arm 30. The front lower control arm 30 has forward facing connector assembly 230 for connecting the lower control arm 30 to the appropriate forward lower control arm connector bracket 510 (shown on FIG. 1) by appropriate means. The front lower control arm 30 has a rearward facing ball joint assembly 240 for connecting the lower control arm 30 to the appropriate rearward lower control arm brackets (not shown) on the vehicle frame (not shown).

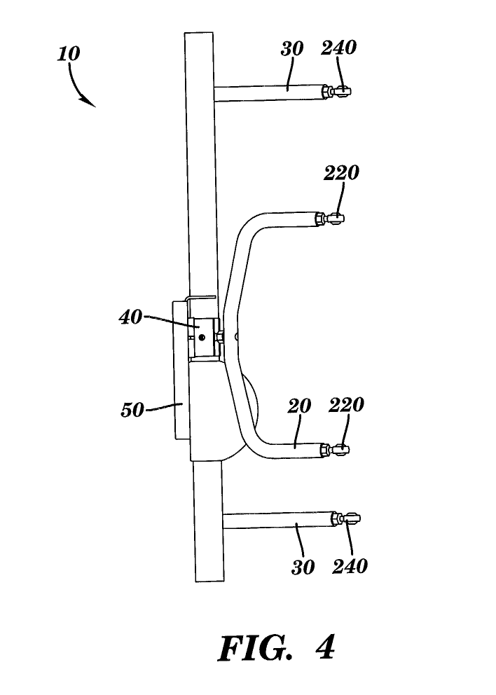

Referring to FIG. 4, the upper control arm 20 is shown. The midpoint ball joint assembly 210 is connected by appropriate means to the upper control arm ball joint bracket 40. The upper control arm ball joint bracket 40 is further connected by appropriate means to the front axle bracket 50. The front axle bracket 50 is connected by appropriate means to the front axle 500.

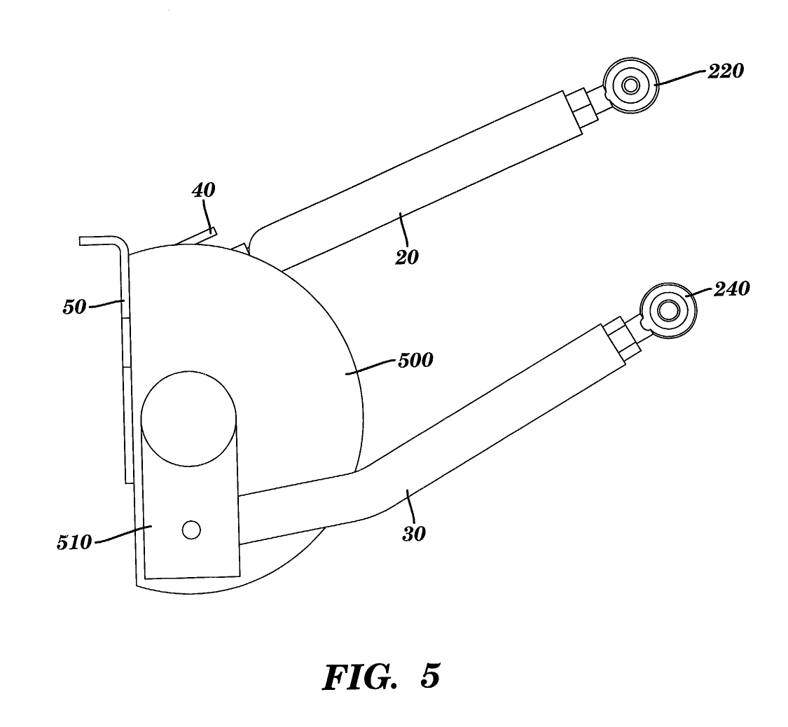

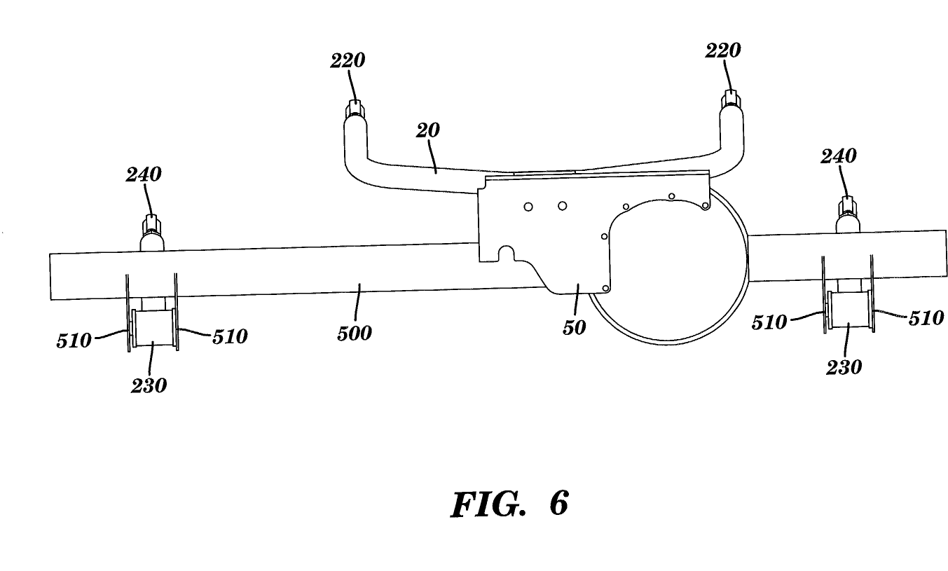

As shown in FIGS. 5 and 6, the forward facing connector assembly 230 of the front lower control arm 30 is connected at the by appropriate means to the to the appropriate forward lower control arm connector bracket 510.

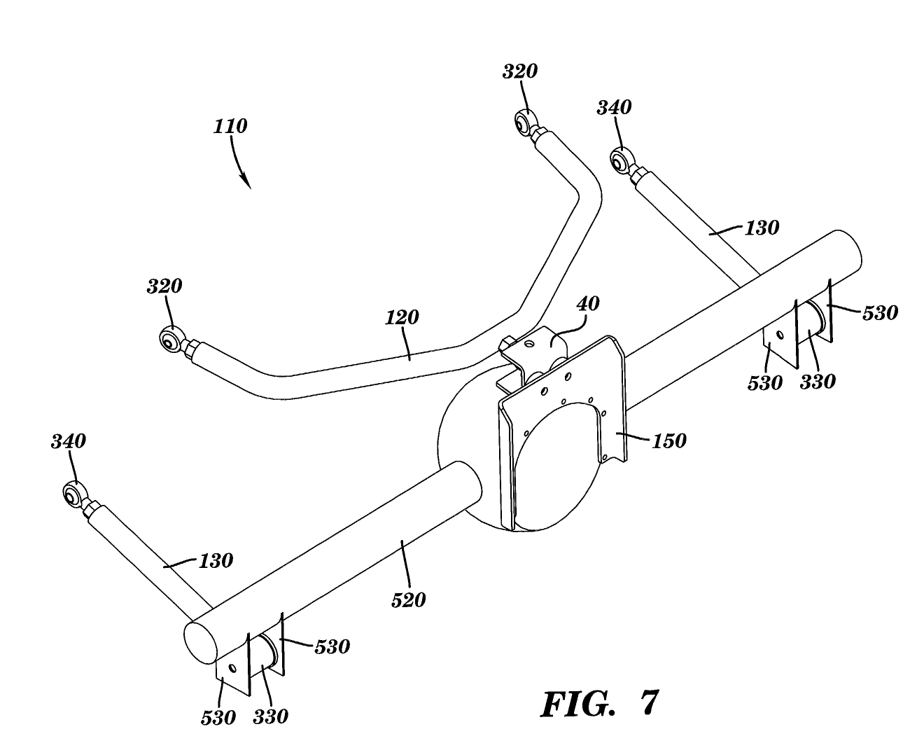

With reference to FIG. 7 of the drawings, the rear axle of a motor vehicle is partially shown and includes a suspension system 110 having an upper rear control arm 120 and right and left lower rear control arms 130, an upper control arm ball joint bracket 140, a rear axle bracket 150, and a rear axle 520 having right and left lower control arm connector brackets 530.

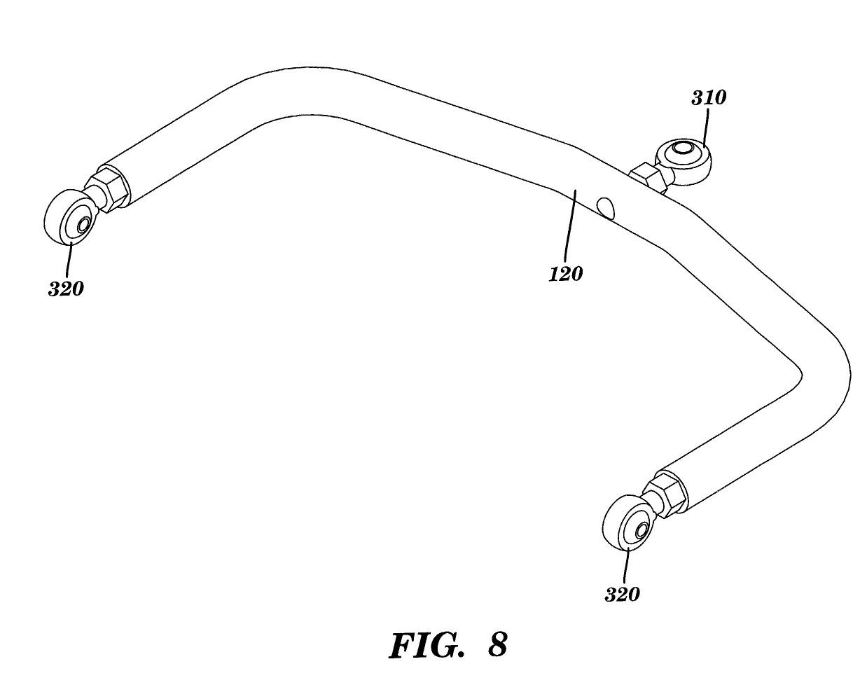

Referring now to FIG. 8, the upper rear control arm 120 is shown. The upper control arm 120 being U-shaped and having a ball joint assembly 310 located at the midpoint of the upper control arm 120. And further having a ball joint assembly 320 at each end of the upper control arm. The midpoint ball joint assembly 310 being connected by appropriate fastening means to the upper control arm ball joint bracket 40, shown in FIG. 7. The ball joint assembly 320 at each end of the upper control arm being connected by appropriate means to the appropriate upper control arm brackets (not shown) on the vehicle frame (not shown).

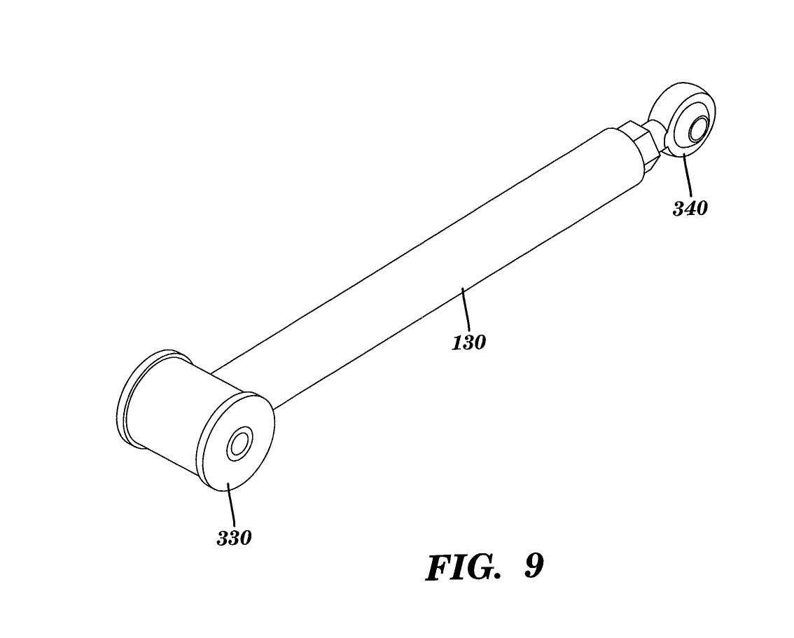

FIG. 9 demonstrates a rear lower control arm 130. The rear lower control arm 130 has forward facing connector assembly 330 for connecting the lower rear control arm 130 to the appropriate forward lower control arm connector bracket 530 (shown on FIG. 7) by appropriate means. The rear lower control arm 130 has a rearward facing ball joint assembly 340 for connecting the lower control arm 130 to the appropriate rearward lower control arm brackets (not shown) on the vehicle frame (not shown).

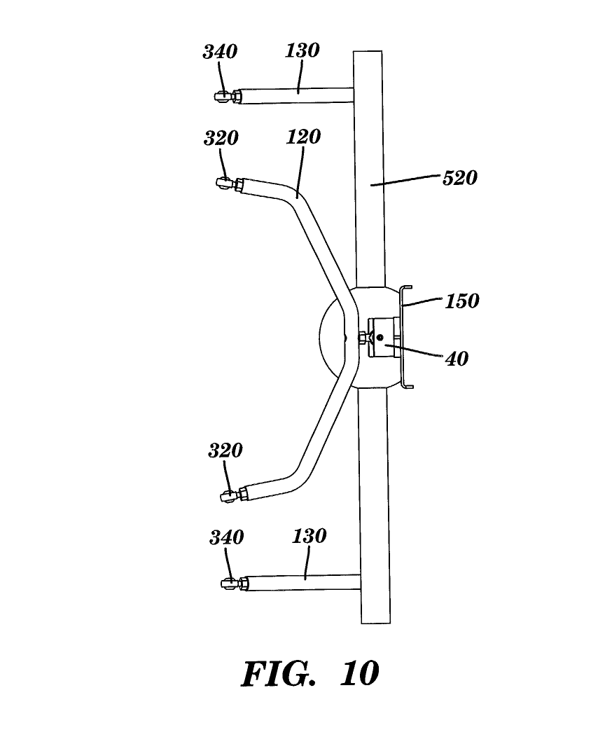

Referring to FIG. 10, the upper control arm 120 is shown. The midpoint ball joint assembly 310 is connected by appropriate means to the upper control arm ball joint bracket 40. The upper control arm ball joint bracket 40 is further connected by appropriate means to the rear axle bracket 150. The rear axle bracket 150 is connected by appropriate means to the front axle 520.

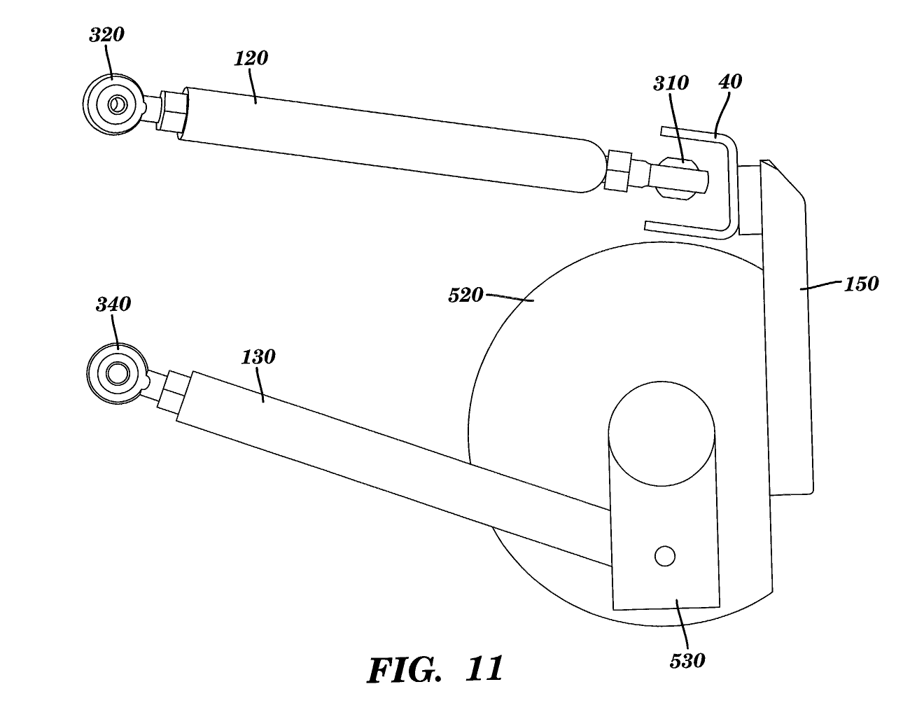

As shown in FIG. 11, the forward facing connector assembly 330 (not shown) of the rear lower control arm 130 is connected at the axle by appropriate means to the appropriate rear lower control arm connector bracket 530.

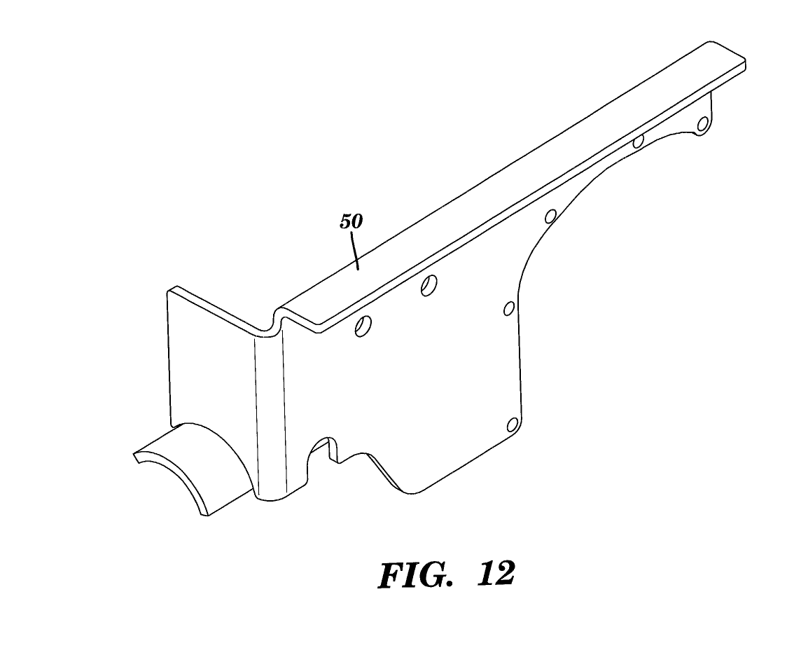

Referring to FIG. 12, the front axle bracket 50 is shown.

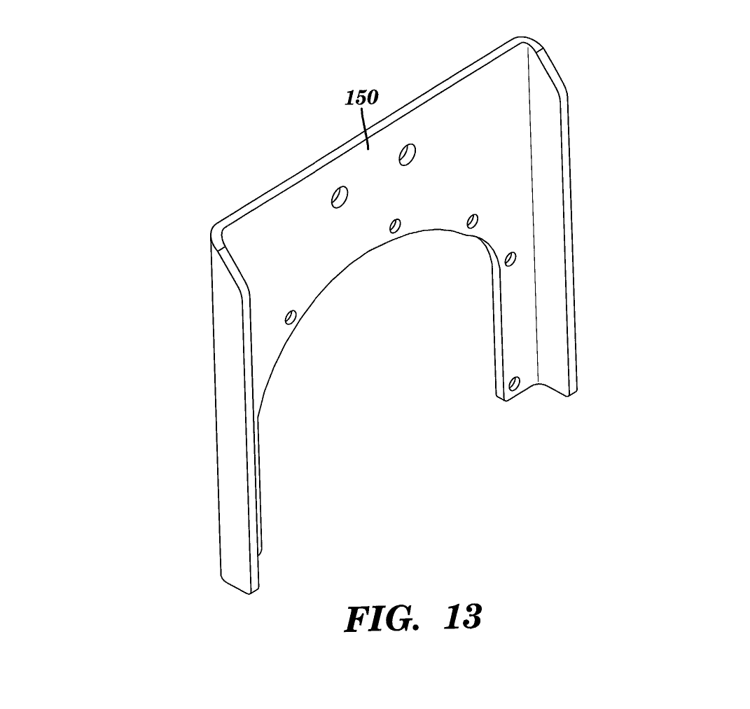

Referring to FIG. 13, the rear axle bracket 150 is shown.

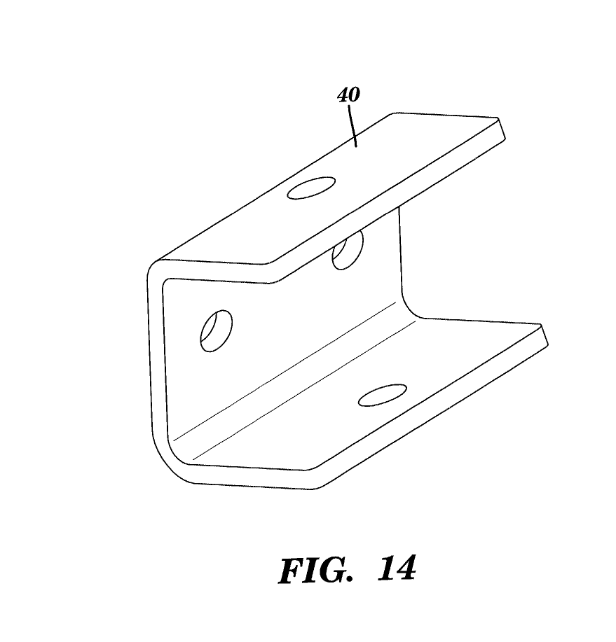

And referring to FIG. 14, the upper control arm ball joint bracket 40 is shown.

In a preferred embodiment an existing 4-link or 5-link suspension system, including the trac bar or sway bar if installed, in a vehicle such as, but not limited to Jeep™ Wrangler™, Jeep™ Cherokee™ and Jeep™ Grand Cherokee™ is removed and the tri-link suspension system of the present invention is bolted into the vehicle. The suspension system of the present invention is applicable to the front axle suspension system as shown in FIG. 1 and the rear axle suspension system as shown in FIG. 7. In the operation of a vehicle equipped with the suspension system of the present invention, vertically-directed impulsive forces resulting from the rolling of the vehicle wheels over various irregularities in the surface of a road or off-road tracks are transmitted through front axle 500 into suspension system 10. Transmission of the impulsive force into suspension system 10 causes the upper and lower control arm assemblies 20 and 30 to pivot about their connection to the vehicle frame, not shown, and upper control arm assembly 20 to pivot about its connection to front axle 500, in the direction of the impulsive force so as to provide front axle 50 with a sufficient amount of freedom to move upward or downward or to articulate and thereby to eliminate or substantially reduce the transmission of the impulsive force to the vehicle occupants as well as prevent the impulsive force from damaging the front axle 50 or vehicle frame. Likewise various irregularities in the surface of a road or off-road tracks are transmitted through rear axle 520 into suspension system 110. Transmission of the impulsive force into suspension system 110 causes the upper and lower control arm assemblies 120 and 130, to pivot about their connection to the vehicle frame, not shown, and upper control arm assembly 120 to pivot about its connection to rear axle 520, in the direction of the impulsive force so as to provide rear axle 530 with a sufficient amount of freedom to move upward or downward or to articulate and thereby to eliminate or substantially reduce the transmission of the impulsive force to the vehicle occupants as well as prevent the impulsive force from damaging the front axle 520 or the vehicle frame, not shown.

In existing suspension systems with a trac bar, various irregularities in the surface of a road or off-road tracks are transmitted through the vehicle axle into the suspension system. Transmission of the impulsive force into suspension system and the axle is constrained by the trac bar which causes the axle to move right or left. In the present invention, the axle is allowed an additional degree of freedom and can move upward or downward or to articulate.

In an alternate embodiment, the installation of the upper control arm assemblies 20 and 120 and the lower control arm assemblies 30 and 130 may be reversed so that the upper control arm assemblies 20 and 120 are installed below the respective front and rear axle and the lower control arm 30 and 130 are installed above the respective front and rear axle.

The foregoing discussion discloses and describes a preferred embodiment of the present invention. One skilled in the art will readily recognize from such discussion, and from the accompanying drawings and claims, that various changes, modifications and variations can be made therein without departing from the true spirit and fair scope of the invention as defined in the following claims.

I claim:

1. A suspension system for attachment with a vehicle axle, the suspension system comprising:
an upper control arm assembly, said upper control arm assembly is U-shaped having a midpoint ball joint assembly located at the midpoint and a end point ball joint assembly located at each end of said upper control arm assembly, said midpoint ball joint assembly is pivotably coupled to the front axle by means of a ball joint bracket and a front axle bracket, said end point ball joint assembly is pivotably coupled to the vehicle frame side rail;
a right side lower control arm assembly, said lower control arm assembly having a forward end pivotably connected to an axle bracket on the right side of the vehicle axle, said lower control arm assembly having a rearward end having a ball joint assembly pivotably coupled to the vehicle right side frame; and
a left side lower control arm assembly, said lower control arm assembly having a forward end pivotably connected to an axle bracket on the left side of the vehicle axle, said lower control arm assembly having a rearward end having a ball joint assembly pivotably coupled to the vehicle left side frame, whereby the vehicles axle maintains a centered position as the axle moves up or down or articulates.

2. The suspension system of claim 1, where in the upper control arm midpoint ball joint assembly, the upper arm end point ball joint assemblies, the right side lower control arm assembly ball joint assembly and the left side lower control arm assembly ball joint assembly are high-misalignment rod ends.

3. A suspension system for attachment with a vehicle axle, the suspension system comprising:
an upper control arm assembly, said upper control arm assembly is U-shaped having a midpoint ball joint assembly located at the midpoint and a end point ball joint assembly located at each end of said upper control arm assembly, said midpoint ball joint assembly is pivotably coupled to the front axle by means of a ball joint bracket and a front axle bracket, said end point ball joint assembly is pivotably coupled to the vehicle frame side rail;
a right side lower control arm assembly, said lower control arm assembly having a forward end pivotably connected to an axle bracket on the right side of the vehicle axle, said lower control arm assembly having a rearward end having a ball joint assembly pivotably coupled to the vehicle right side frame; and
a left side lower control arm assembly, said lower control arm assembly having a forward end pivotably connected to an axle bracket on the left side of the vehicle axle, said lower control arm assembly having a rearward end having a ball joint assembly pivotably coupled to the vehicle left side frame, whereby the vehicles axle maintains a centered position wherein the vehicle axle has an additional degree of freedom to move up or down or articulate.

4. The suspension system of claim 3, where in the upper control arm midpoint ball joint assembly, the upper arm end point ball joint assemblies, the right side lower control arm assembly ball joint assembly and the left side lower control arm assembly ball joint assembly are high-misalignment rod ends.
